(19) United States
(12) Patent Application Publication
(10) Pub. No.: US 2025/0297554 A1
(43) Pub. Date: Sep. 25, 2025

(54) AIRCRAFT TURBOMACHINE HAVING VARIABLE-PITCH PROPELLER VANES

(71) Applicant: SAFRAN AIRCRAFT ENGINES, Paris (FR)

(72) Inventors: Vincent JOUDON, Moissy-Cramayel (FR); Julien David Alexandre TREBAOL, Moissy-Cramayel (FR); Thierry Georges Paul PAPIN, Moissy-Cramayel (FR); Richard Anandavelou MOUNIEN, Moissy-Cramayel (FR); Damien David Denis DAM, Moissy-Cramayel (FR)

(21) Appl. No.: 18/863,300

(22) PCT Filed: May 5, 2023
(86) PCT No.: PCT/FR2023/000081

§ 371 Date: Nov. 5, 2024

(30) Foreign Application Priority Data
May 10, 2022 (FR) FR2204388

(51) Int. Cl. F01D 7/00; F01D 5/30

(52) U.S. Cl. CPC F01D 7/00; F01D 5/30; F05D 2260/79

(57) ABSTRACT

An assembly including a propeller blade and a system for angularly setting the pitch of the blade for an aircraft turbomachine, the blade having a root extending from an upper end connected to an airfoil of the blade to a free lower end, the root having a bulging segment, which bulging segment is referred to as the “bulb”, the system for angularly setting the pitch of the blade including a cup which is radially defined by an annular wall and which includes a lower bottom closed by a bottom wall and an upper opening through which the bulb is intended to be axially inserted into the cup, the bottom wall including a protrusion which engages with a cavity having a complementary shape in the free end of the root.

### TECHNICAL FIELD OF THE INVENTION

The present invention relates to the field of the aircraft turbomachines and in particular to the propulsion propellers of these turbomachines which comprise variable pitch vanes.

### TECHNICAL BACKGROUND

The technical background comprises the documents U.S. Pat. No. 8,753,088 and DE-C-921 788.

An aircraft turbomachine propeller can be ducted, as in the case of a fan for example, or unducted, as in the case of an open-rotor architecture for example.

A propeller comprises vanes which may be pitch variable. The turbomachine then comprises a mechanism allowing for changing the pitch angle of the vanes in order to adapt the thrust generated by the propeller to different phases of flight.

The design of a propeller vane involves several disciplines with generally conflicting objectives. It must allow optimal aerodynamic performance (i.e. provide a thrust while maximising the efficiency), guarantee a mechanical strength of the vane (i.e. withstand the mechanical constraints resulting from static and dynamic loadings) while limiting the mass and the acoustic signature. In particular, the improvement in the aerodynamic performance of the propeller tends towards an increase of the BPR (By Pass Ratio), which translates into an increase in its external diameter and therefore in the span of the vanes.

At the same time, in some turbomachine architectures, the engine is started at a very open pitch, referred to as feathering. In fact, this starting position allows the power to be consumed by the torque, which ensures the machine safety by guaranteeing low propeller speeds. More precisely, according to simple considerations, the power is proportional to the product of the speed and the torque. However, the torque increases with the angle of incidence, which can be increased by means of the pitch. Indeed, the person skilled in the art in aerodynamics understands that the resulting force on a blade profile is, to a first approximation, perpendicular to the chord and can be broken down into two components: the thrust along the engine axle and the drag of the blade in the plane of the propeller. Thus, as the pitch of the vanes increases, the resulting force displaces towards the propeller plane, increasing the drag of the aerodynamic profile and decreasing the thrust.

Therefore, in the case of feathered start, the thrust generated by the propeller is zero, the torque is maximum and the speed is minimum. However, the incidence becomes so high that the blades are subjected to a turbulent, highly lifted aerodynamic flow which generates a strong vibratory excitation. This excitation is both broadband due to the small vortexes in the lifted area, but also intense at certain specific frequencies due to the large Karman re-circulations which cause the aerodynamic force to oscillate significantly. In particular, on large chord and large span blades that generate a lot of drag, this force is intense even though the speed is not high.

In the current technique, it is common practice to attach a vane to its support with an attachment referred to as broached. The vane comprises a root which has a general dovetail shape and which is intended to be engaged in a form-fitting manner in a pocket of the support, this pocket being conventionally produced by broaching.

However, this type of fixing does have its drawbacks. In particular, the aerodynamic force can cause the root of vane to move rigidly in its slot, which is similar to ball-jointing, resulting in frictional damage to the blade and the wedge inserted between the root and the bottom of the slot, in just a few cycles. The pinned fastener is therefore not a viable solution for propeller vanes with variable pitch, wide chord and large span.

In the documents FR-A1-3 112 819 and FR-A1-3 112 820, the Applicant proposed a type of bulb fastener. The vane is fitted with an adapted root to limit the risk of ball-jointing. The special characteristic of this root of the vane is the bulged section, which ensures optimum retention of the vane along its axis. Compared with a pinned fastener, this technology reduces premature wear of the vane during phases of flight that are likely to excite the vibratory modes of the vane. In addition, the vane root is very advantageous in terms of overall dimension and aerodynamic profile fineness.

The vane is part of an assembly that also comprises a system for angularly pitching the vane about a so-called pitch axis. The pitch system comprises a cup which includes an annular wall extending around the axis, a lower bottom closed by a bottom wall, and an upper opening through which the bulb is intended to be inserted into the cup.

The bottom wall is designed to cooperate in a form-fitting manner with the free end of the root so that the cup is secured against rotation with the root about the axis.

In the aforementioned documents, the free end of the root comprises a protuberance which is engaged in a recess in the bottom wall of the cup. This protuberance is cumbersome and represents a significant mass for the vane, which therefore has an impact on its operating behaviour.

The present invention is an improvement on this technology, which is simple, effective and economical.

### SUMMARY OF THE INVENTION

The invention provides an assembly comprising a propeller vane and a system for angularly setting the pitch of the vane about an axis, called the pitch axis, for an aircraft turbomachine,
the vane having a root extending from an upper end connected to a blade of the vane to a free lower end, the root having a bulged section, called a “bulb”,
the system for angularly setting the pitch of the vane comprising a cup which is radially delimited by an annular wall extending around the pitch axis, the cup comprising a lower bottom closed by a bottom wall and an upper opening through which the bulb is intended to be inserted axially into the cup, the bottom wall being configured to cooperate in a form-fitting manner with the free end of the root so that the cup is secured against rotation with the root around the pitch axis,
characterised in that the bottom wall comprises a protuberance which extends along the pitch axis and which is engaged in a recess of complementary shape to the free end of the root.

The present invention thus proposes to reverse the configuration of the previous technique and to provide the recess in the free end of the bulb-shaped root, and therefore the protuberance on the bottom of the cup. This is particularly advantageous because it reduces the footprint of the root and, above all, the weight. The mass of the vane is therefore reduced, which has a positive effect on its operating behaviour, particularly under the effect of centrifugal forces.

The assembly according to the invention may comprise one or more of the following characteristics, taken alone from each other, or in combination with each other:
the recess and the protuberance are off-centre with respect to said pitch axis;
the recess and the protuberance are centred on said pitch axis;
the recess is formed in a metal material part of the root;
the recess is formed in a composite material part of the root;
the recess and the protuberance have, in cross-section, a shape selected from an ellipse, a star, a cross and a polygon;
the cross-section of the bulb is rounded and convex around the pitch axis;
the bulb is connected to the blade by a stilt with a smaller cross-section than the bulb;
the protuberance has a smaller cross-section than the bulb;
the protuberance has a smaller cross-section than the stilt.

The invention also relates to an aircraft turbomachine comprising an assembly as described above.

### BRIEF DESCRIPTION OF THE FIGURES

Further characteristics and advantages of the invention will become apparent from the following detailed description, for the understanding of which reference is made to the attached drawings in which:

FIG. 1 is a schematic perspective view of a propeller vane for an aircraft turbomachine,

FIG. 2 is a larger scale view of a portion of FIG. 1 and shows the root of the vane,

FIG. 3 is a cross-sectional view along sectional plane Pb in FIG. 4, showing the shape and position of the free lower end of the root relative to the pitch axis,

FIG. 4 is an axial sectional view showing the root of the vane of FIG. 1 fixed in a cup of a pitch system of an assembly according to the prior art,

FIG. 5 is a similar view to FIG. 4 and shows an axial section of an assembly according to one embodiment of the invention,

FIG. 6 is a similar view to FIG. 5 and shows in axial section an assembly according to an alternative embodiment of the invention, and

FIGS. 7a to 7i are highly schematic views of vane root protuberances and show several variants of the invention.

### DETAILED DESCRIPTION OF THE INVENTION

In the following description, elements with an identical structure or similar functions will be referred to by a same reference.

In the remainder of the description, an axial orientation along the pitch axis “A” of the vane is adopted in a non-limiting way, from the bottom, near the root of the vane, upwards, near the free end of the vane. Radial directions extending orthogonally to the pitch axis from the inside, close to the pitch axis, outwards are also adopted.

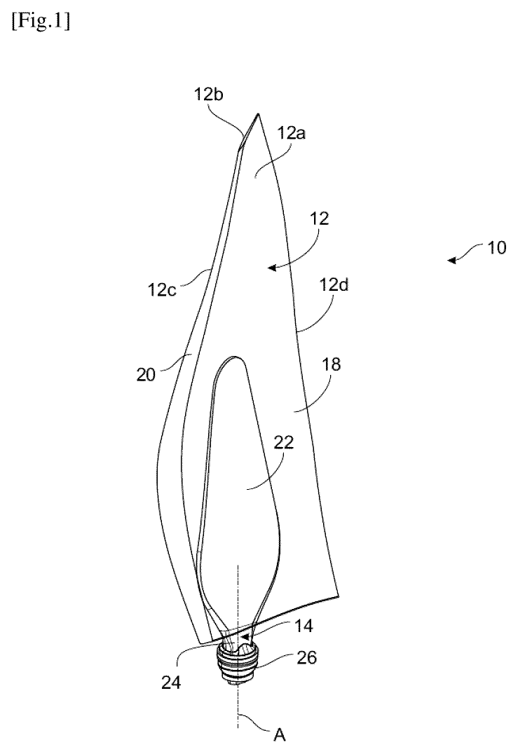

FIG. 1 shows a vane 10 for a propeller of an aircraft turbomachine, this propeller being either ducted or un-ducted.

The vane 10 comprises a blade 12 connected to a root 14.

The blade 12 has an aerodynamic profile and comprises a pressure side 12a and a suction side 12b which are connected by an upstream leading edge 12c and a downstream trailing edge 12d, the terms upstream and downstream referring to the flowing of the gases around the blade 12 in operation.

The blade 12 has an upper end which is free, referred to as summit, and a lower end which is connected to the root 14.

In the example shown, the vane 10 is made of a composite material by an injection method referred to as RTM method (Resin Transfer Molding). This method consists of preparing a fibrous preform 18 by three-dimensional weaving, then placing this preform in a mould and injecting a polymerizable resin, such as an epoxy resin, which will impregnate the preform. After the blade 12 has cured and hardened, its leading edge 12c is usually reinforced by a metal sheath 20 which is fitted and attached, for example by gluing.

The vane 10 comprises a spar 22. The spar 22 comprises a part forming a web of the blade 12. The part of the spar 22 forming the web of the blade 12 is intended to be inserted into the preform 18 prior to the resin injection. The spar 22 also comprises a part that extends on the opposite side of the summit of the blade 12 to form the root 14.

The spar 22 is preferably made of composite material. For example, it is a 3D woven carbon fibre reinforced epoxy organic matrix composite material with the warp direction predominantly radial and the weft predominantly oriented according to the chord of the blade 12 at aerodynamic duct height.

Alternatively, the spar can also be formed by a more mechanically advantageous assembly of different organic matrix composite materials (thermoset, thermoplastic or elastomer) reinforced with long fibres (carbon, glass, aramid, polypropylene) in several fibre arrangements (woven, braided, knitted, unidirectional).

Although not shown, the blade 12 may be hollow or solid and comprise an internal cavity filled with a filling material of the foam or honeycomb type. This filler material is installed around the spar 22 and is covered with a skin of organic matrix composite material to increase the impact resistance of the blade 12.

The sheath 20 may be titanium or titanium alloy, stainless steel, steel, aluminium, nickel, etc. The intrados 12a or even the extrados 12b of the blade 12 may be covered with a polyurethane film for the protection against erosion.

The root 14 is here without a metal annular barrel enveloping it.

The axis “A” is an axis of elongation of the vane 10 and of the blade 12 and in particular a pitch axis “A” of the vane 10, i.e. the axis about which the angular position of the vane 10 is adjusted. It is generally also a radial axis which therefore extends along a radius with respect to the axis of rotation of the propeller equipped with this vane 10.

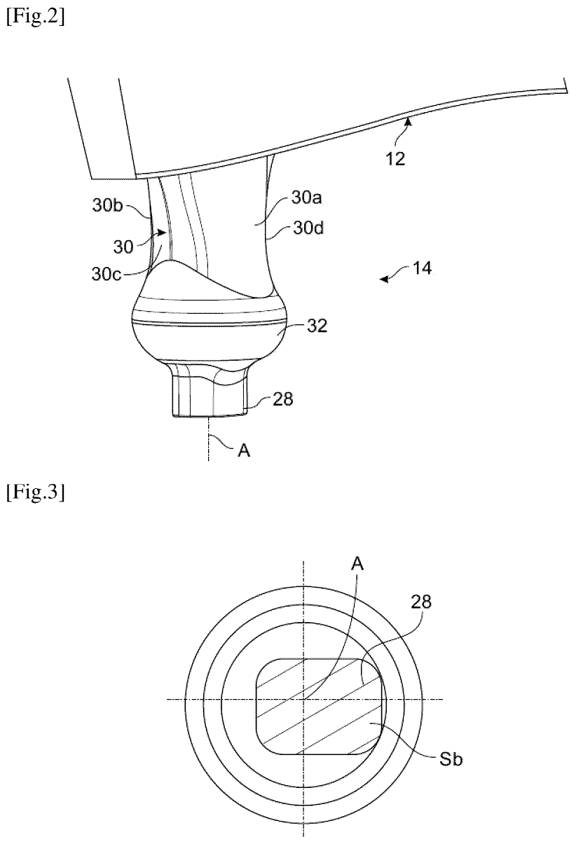

The root 14 has a particular shape which is best seen in FIG. 2. The root 14 essentially comprises three portions:
a free lower end 28 located opposite the blade 12,
an upper stilt 30 located on the side of the blade 12, and
a bulged section, referred to as “bulb” 32, located between the free end 28 and the stilt 30.

The free end 28 has a generally parallelepiped shape in the example shown. As can be seen in FIG. 3, this free end 28 is offset from the pitch axis “A” to achieve a keying or an indexing, as will be explained in more detail below.

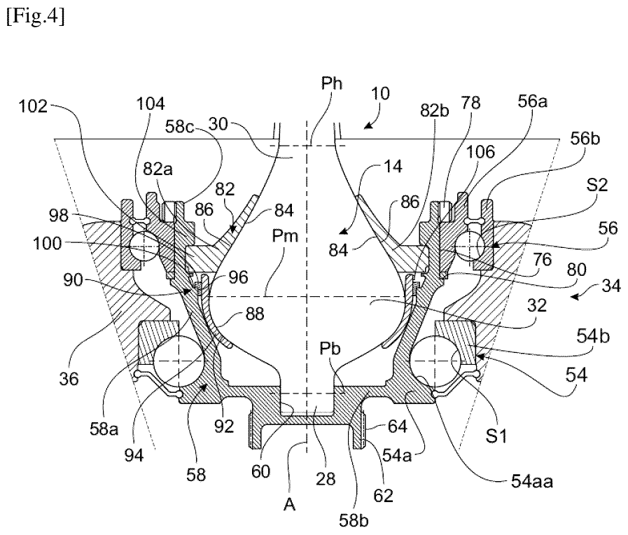

Referring to FIG. 4, Pb is defined as a transverse plane, i.e. a plane perpendicular to the pitch axis “A”, passing substantially through the middle of the free end 28, measured along the pitch axis “A”. This plane Pb is referred to as bottom or lower plane. FIG. 3 shows the cross-sectional shape of the free end 28 in this plane Pb. This section, referred to as low section, has a value or a surface area, for example maximum, denoted Sb and is generally rectangular in shape in the example shown.

As will also be described below, the free end 28 is configured to cooperate with a system 34 for angularly setting the pitch of the vane 10.

Referring again to FIG. 2, the stilt 30 has a relatively complex shape which allows to provide a transition between the root 14 and the spar portion 22 forming the core of the blade 12. The stilt 30 comprises schematically:
two lateral flanks 30a, 30b, located respectively on the side of the pressure side 12a and the suction side 12b of the blade 12, which converge towards each other along the pitch axis “A” and towards the summit of the blade 12, and
two edges, respectively upstream 30c and downstream 30d, which on the contrary diverge from each other along the pitch axis “A” and towards the summit of the blade 12.

With reference to FIG. 4, Ph is defined as a transverse plane passing through the stilt 30, and in particular the lower end of the stilt 30. This plane Ph is referred to as high or upper plane. In this plane, the stilt 30 may have a non-circular cross-sectional shape, for example oval, oblong, square or rectangular. This section, referred to as high section, has a value or a surface area, for example maximum, noted Sh.

The bulb 32 has a generally bulging or domed shape, this bulge or doming extending around the pitch axis “A”.

Pm is defined as a median plane passing through the bulb 32, and in particular in its portion of greatest cross-section, hereafter referred to as middle section, which is noted Sm. This plane Pm is referred to as mean plane. In this plane, the bulb 32 may have a circular shape in section, although this section is not limiting.

It is understood that the plane Pm is located between the planes Pb and Ph. The maximum cross-sectional dimensions of the bulb 32 decrease from the plane Pm (Sm) to the plane Ph, and from the plane Pm towards the plane Pb. It is therefore understood that Sm is greater to Sb and Sh. Furthermore, in the example shown, Sh is greater than Sb.

The vane 10 is intended to be mounted in an angular pitch system 34 which allows its angular position to be changed about the pitch axis “A” relative to a hub 36 of the propeller.

For this purpose, the angular pitch system 34 comprises bearings 54, 56. The bearings 54, 56 are here two in number and are respectively a lower bearing 54 and an upper bearing 56.

The bearings 54, 56 are of the ball rolling type. In the example shown, they have different diameters and their balls also have different diameters.

The lower bearing 54 extends substantially between the planes Pm and Pb and thus around a lower portion of the bulb 32. This lower bearing 54 has a smaller diameter than the upper bearing 56, and its balls have a larger diameter than those of the upper bearing 56.

The lower bearing 54 is also oblique-contact. In the example shown, the bearing points or surfaces of the balls on the raceways of their rings 54a, 54b are located on a frustoconical surface S1 which extends along the pitch axis “A” and whose largest diameter is located on the side of the summit of the vane 10.

The upper bearing 56 extends substantially between the planes Pm and Ph and thus around an upper portion of the bulb 32. The upper bearing 56 is also angular contact. In the example shown, the bearing points or surfaces of the balls on the raceways of their rings 56a, 56b are located on a frustoconical surface S2 which extends along the pitch axis “A” and the largest diameter of which is located on the side of the free end 28 of the root 14 of the vane 10.

FIG. 4 illustrates an example of an angular pitch system 34.

The angular pitch system 34 comprises a cup 58. The cup 58 comprises an annular wall 58a extending around the pitch axis “A”. The annular wall 58a radially delimits an internal volume of the cup 58. The internal volume of the cup 58 is closed downwards by a bottom wall 58b which extends opposite the free end 28 of the root 14. The cup 58 has at its upper axial end an opening 58c which is radially delimited by an upper end edge of the annular wall 58a. The free end 28 and the bulb 32 of the root 14 are intended to be inserted axially inside the cup 58 through the upper opening 58c.

The annular wall 58a and the bottom wall 58b are produced in one part.

The bottom wall 58b is configured to cooperate in a form-fitting manner with the free end 28 of the root 14 so that the cup 58 is secured in rotation to the root 14 about the pitch axis “A” and thus constitutes a pivot for the associated vane 10.

In the present case, it is understood that the bottom wall 58b comprises a recess 60 having a non-circular, and in particular rectangular, cross-section and configured to receive the free end 28, as illustrated in FIGS. 3 and 4. As can be seen in FIG. 2, this recess 60 is eccentric with respect to the pitch axis “A” in a similar manner to the free end 28. This eccentricity allows an indexing and a keying when inserting and mounting the root 14 in the cup 58, with only one engagement position of the free end 28 in the recess 60 being possible.

The recess 60 is located on an upper or internal face of the bottom wall 58b of the cup 58, which is thus located inside the cup 58 and oriented on the side of the root 14.

The angular pitch system 34 generates a torque at the root 14 of vane 10 which counteracts the torsional moment resulting from aerodynamic and centrifugal forces. It is advantageous to insert the free end 28 directly into the recess 60, without the interposition of a fitted element, in order to directly force the rotation of the root 14. This provides a more direct force path, with the torsional moment applied directly to the root 14. The low section has dimensions strictly smaller than the maximum dimension of the middle section in order to limit the circumferential overall dimension to this height.

The position of the middle stretch, the most radially bulky section of the bulb 32, between the two bearings 54, 56, is very advantageous in terms of radial overall dimension because a portion of the bearing surface height between the middle section and the high section is located inside the cup 58, contrary to the prior art on broached attachments integrated in a pivot. This helps to reduce the radial overall dimension of the angular pitch system 34.

This allows to reduce the diameter of the lower bearing 54 which is located below the middle section. Thus, the root 14 of vane 10 can be integrated lower along the pitch axis “A”, which greatly reduces the theoretical hub ratio associated with the integration of the root 14. It is known to the person skilled in the art that a low hub ratio improves the performance of the engine, in particular as it is more compact and therefore lighter. This last point is a very important advantage of the technical solution compared to the competition, which traditionally proposes barrels with cylindrical external shape.

The bottom wall 58b comprises a lower or external face, which is located on the opposite side of the root 14, and which comprises a cylindrical extension 62 extending along the pitch axis “A” and comprising an external thread or external straight splines 64 for rotational coupling of the angular pitch system 34 with a pitch change mechanism which is not illustrated and which is common to the different angular pitch systems 34 and vanes 10 of the propeller.

As can be seen in FIG. 4, the cup 58 is designed to support the bearings 54, 56 which ensure the centring and the guiding of the cup 58 about the pitch axis “A” with respect to the hub 36 of the turbomachine.

The bearings 54, 56 may form part of the angular pitch system 34. In particular, at least one of the guide bearings may have its internal ring which is integrated to the cup 58.

This is the case for the lower bearing 54 which has its internal ring 54a integrated into the cup 58. In practice, this means that the cup 58 comprises a raceway 54aa at its external periphery on which the balls of the lower bearing 54 roll directly. This raceway comprises an annular surface with a concave curved section. This raceway is located at the lower end of the cup 58 and the annular wall 58a. The external ring 54b of the lower bearing 54 is attached to the hub 36, for example by shrink-fitting. Furthermore, the cup 58 is advantageously designed to apply a preload to the lower bearing 54.

The external ring 56b of the upper bearing 56 is attached to the hub 36, for example by shrink-fitting. Its internal ring 56a is engaged over and around the free upper end of the cup 58 and the annular wall 58a. This end of the annular wall 58a comprises an external cylindrical surface 76 for mounting the internal ring 56a as well as an external thread for screwing on a nut 78 intended to be axially supported on the internal ring 56a to maintain it clamped axially against an external cylindrical shoulder 80 of the cup 58.

To retain the root 14 axially inside the cup 58, in particular against the centrifugal force, an annular retaining ring gear 82 is provided which extends inside the cup 58, around the bulb 32. The retention ring gear 82 is connected to the cup 58 so as to be at least limited in axial displacement towards the opening 58c relative to the cup 58.

The retention ring gear 82 has an annular bearing surface face 84 directed towards the bottom of the cup 58. The bearing surface face 84 is intended to restrict the passage cross-section of the opening 58c of the cup 58 to prevent the removing of the root 14 through the opening 58c by impediment with the bulb 32. More particularly, the bearing surface face 84 is intended to be in axial contact with an upper face 86 of the bulb 32 to block the axial displacement of the bulb 32 towards the upper opening 58c.

It is also important to strongly attach the root 14 in the cup 58 to prevent any swivelling of the vane 10 relative to the cup 58 during its use. To this end, the angular pitch system 34 comprises a lower seat 88, formed by a face turned towards the opening 58c of the cup 58, by means of which the root 14 is axially supported in the cup 58 in the direction of the bottom.

The seat 88 is a separate part from the retention ring gear 82. At least one of the seat 88 and/or the retention ring gear 82 is mounted movable in axial translation with respect to the cup 58 by means of at least one clamping mechanism 90 to allow the bulb 32, here made of composite material, to be axially clamped between the seat 88 and the bearing surface face 84 of the retention ring gear 82. This allows to prevent an axial clearance between the bearing surface face 84 and the vane 10.

In order that such axial clearance does not occur, whatever the operating conditions of the propeller, the bulb 32 is clamped between the seat 88 and the bearing surface face 84 of the retention ring gear 82 with a sufficiently high pre-stress to exceed the maximum axial forces likely to be applied to the vane 10 during operation of the propeller, for example of the order of several tens of thousands of Newtons.

The retention ring gear 82 is made of a metallic material, such as steel, titanium or a titanium alloy such as TA6V.

The seat 88 is made of a metallic material, such as steel, titanium or a titanium alloy such as TA6V.

To ensure that the vane 10 is retained axially in the cup 58 without clearance, the bearing surface face 84 of the retention ring gear 82 is directly in contact with the bulb 32, without the interposition of an insert. In particular, the bearing surface face 84 of the retention ring gear 82 has a shape complementary to the upper face 86 of the bulb 32 to distribute the forces over a large area of the bulb 32.

To simultaneously allow the root 14 to be maintained radially in the cup 58, the upper face 86 of the bulb 32 has a generally frustoconical shape and the bearing surface face 84 has a complementary shape. The bearing surface face 84 extends, for example, generally from the median plane to the opening 58c of the cup 58. Thus, under the effect of the centrifugal force, the root 14 becomes radially centred in the bearing surface face 84. This shape therefore allows to provide a stable position of the vane 10 with respect to the pitch axis “A” during the propeller rotation.

Compared to a broached attachment, the surface area of the bearing surface face 84 is maximised by exploiting the entire circumference of the bottom of the vane 10. In a broached attachment, only two distinct surfaces of the root 14 of vane 10, respectively located on the pressure side and the suction side, are supported on bearing surfaces, whereas the surfaces of the root 14 of vane 10 located on the leading edge and trailing edge are free. Also in comparison to a broached attachment, the height of the bearing surfaces in the direction of the pitch axis “A” is much greater, which also contributes to a considerable increase in their surface area. This large support surface allow to reduce the contact pressure in all operating conditions.

The inner diameter of the retention ring gear 82, measured at the upper end of the bearing surface face 84, is substantially smaller than the diameter of the middle section of the bulb 32. To allow it to be arranged around the bulb 32 in a simple manner, the retention ring gear 82 is here produced of several sectors, of which two sectors 82a, 82b are shown in FIG. 4. These sectors 82a, 82b are evenly distributed around the pitch axis “A”.

These sectors 82a, 82b may be circumferentially in contact with each other so that the bearing surface face 84 has a continuous annular shape.

In a variant which will be detailed later, the sectors 82a, 82b are spaced circumferentially from each other so that the bearing surface face 84 has an annular shape with discontinuities between two sectors 82a, 82b.

The root 14 is supported on the seat 88 by a lower face 92 of the bulb 32. The seat 88 is thus in the form of an annular support face which extends around the pitch axis “A”. In particular, the seat 88 conforms the lower face 92 opposite the bulb 32, in particular to allow the contact pressure between the seat 88 and the bulb 32 to be reduced. The seat 88 is in direct contact with the root 14, here made of composite material.

To allow the bottom of the root 14 to be centered in the cup 58, the lower face 92 of the bulb 32 in contact with the seat 88 has a generally frustoconical shape, here convex, and the seat 88 has a complementary shape. Thus, the root 14 is not only axially supported towards the bottom of the cup 58 but is also maintained in position radially in the cup 58.

Alternatively, the seat rests against a lower face of the free end of the root.

In the example shown in FIG. 4, the seat 88 is supported by at least one add-on component in the cup 58. The seat 88 is thus interposed between the root 14 and the cup 58. The seat 88 is mounted movable in translation by means of at least one clamping mechanism 90.

The seat 88 is here formed by the upper face of an annulus 94 produced in one part. The seat 88 is intended to be supported against a lower annular face of the bulb 32. In this respect, the seat 88 has a continuous annular shape centered on the pitch axis “A”.

The annulus 94 carrying the seat 88 is mounted in axial support towards the bottom of the cup 58 by means of a clamping ring 96 belonging to the clamping mechanism 90. The clamping ring 96 surrounds the seat 88.

The clamping ring 96 has an external peripheral rim 98 which is supported against an annular shoulder face 100 of the cup 58. The shoulder face 100 extends radially inwardly from the annular wall 58a and is turned towards the opening 58c. This shoulder face is located slightly above the median plane Pm.

The clamping ring 96 is intended to cooperate with the annulus 94 to clamp the seat 88 axially upwards against the bulb 32 by being supported on the shoulder face 100. For this purpose, the clamping ring 96 is secured in axial displacement to an internal thread which screws onto a complementary external thread produced on an external face of the annulus 94.

To allow the seat 88 to be clamped against the bulb 32 by turning the clamping ring 96, one of the external thread or the external thread is blocked against rotation with respect to the cup 58.

By way of a non-limiting example, this refers to the internal thread. In this respect, the clamping ring 96 is immobilised from rotating relative to the cup 58, in particular by nesting complementary shapes between the clamping ring 96 and the cup 58, for example by means of flats or pins.

In the example shown in FIG. 4, the external thread is produced in one part with the seat 88.

In a variant not shown, the external thread is formed by a ring fitted to the annulus and axially secured to the seat. Said ring is for example rotatably mounted around the annulus.

Furthermore, the retention ring gear 82 is fitted to the cup 58. It is produced of several distinct sectors 82a, 82b which are intended to be connected axially to the cup 58 by a dog clutch device. To facilitate the insertion of the sectors 82a, 82b, the retention ring gear 82 is produced of at least three sectors, of which only two are shown in FIG. 4.

Thus, each sector 82a, 82b comprises at least one external dog tooth 102 configured to cooperate with complementary internal dog teeth 104 of the annular wall 58a of the cup 58. For example, the external dog teeth 102 each have an angular extension about the pitch axis “A” of between approximately 20 and 30°.

The internal dog teeth 104 of the cup 58 are evenly spaced around the pitch axis “A”. There are six in the non-limiting example shown. For example, they each have an angular extension about the pitch axis “A”, of between approximately 20 and 30°.

The external dog teeth 102 are complementary to the internal dog teeth 104 and are configured to cooperate by dog clutch with these internal dog teeth 104. The dog clutch is a well-known method of mounting in the aeronautical field and will be described in more detail later.

When mounting the assembly formed by the vane 10 and the angular pitch system 34, the annulus 94 carrying the seat 88 is first inserted into the cup 58 through its upper opening 58c. The annulus 94 is pre-screwed with its clamping ring 96 so that the seat 88 occupies its lowest position in the cup 58 when the ring 96 is pressed against the shoulder face 100. The annulus 94 and its clamping ring 96 are positioned so that the rim 98 of the clamping ring 96 is supported on the shoulder face 100 of the cup 58.

Then the root 14 is inserted with its free end 28 through the upper opening 58c of the cup 58. The root 14 is positioned so that the bulb 32 is bearing against the seat 88.

Then the sectors 82a, 82b of the retention ring gear 82 are inserted into the cup 58 through its upper opening 58c. This insertion is facilitated by the fact that the seat 88 is in its lowest position. This provides a sufficient space for the insertion of the external dog teeth 102 between the internal dog teeth 104 without being impeded by the bulb 32.

The external dog teeth 102 of the sectors 82a, 82b are arranged axially coincident with the spaces angularly between the internal dog teeth 104. Then the external teeth 102 of each sector 82a, 82b are inserted axially downwards into these spaces so as to be below the level of the internal dog teeth 104. Finally, the sectors 82a, 82b are rotated about the pitch axis “A” until the external dog teeth 102 are axially in line with the internal dog teeth 104. Thus, the sectors 82a, 82b of retention ring gear 82 are limited in axial displacement towards the opening 58c by contact of their external dog teeth 102 against the internal dog teeth 104 of the cup 58.

Subsequently, the clamping mechanism 90 is operated to allow the seat 88 to be clamped axially against the bulb 32. This has the effect of raising the root 14 relative to the cup 58 towards its upper opening 58c, until the bulb 32 is axially supported against the bearing surface face 84 of the retention ring gear 82. Thus, the clamping force is transmitted from the seat 88 to the bulb 32, then from the bulb 32 to the retention ring gear 82, and from the retention ring gear 82 to the cup 58 via the dog teeth 102, 104. A reaction force takes place between the clamping ring 96 and the cup 58 via the shoulder face 100. The root 14 is thus only in direct contact with the bearing surface face 84 of the retention ring gear 82 and with the seat 88 of the annulus 94.

For the actuation of the clamping mechanism 90, an interval is angularly reserved between at least two sectors 82a, 82b of retention ring gear 82 to allow the insertion of a clamping tool (not shown) through the upper opening 58c. Here, the clamping is carried out by means of a tool comprising at least one pinion which is inserted into the cup 58. The pinion is intended to be meshed with an external toothing 106 carried by the periphery of the seat 88. The external toothing 106 is here arranged just above the clamping ring 96.

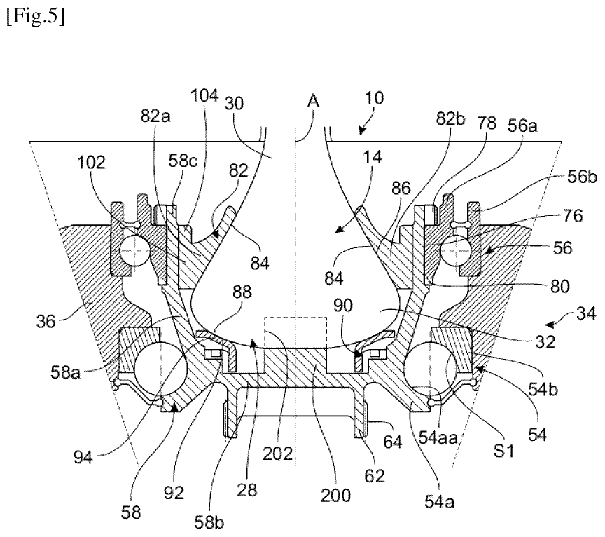

FIG. 5 illustrates a first embodiment of the invention in which the elements already described above are referred to by the same numbers.

The bottom wall 58b is configured to cooperate in a form-fitting manner with the free end 28 of the root 14 so that the cup 58 is secured in rotation to the root 14 about the pitch axis “A” and thus constitutes a pivot for the associated vane 10.

In the embodiment shown in FIG. 5, the bottom wall 58b comprises a protuberance 200 configured to be engaged in a recess 202 of complementary shape to the free end 28 of the root.

In the example shown, it can be seen that the protuberance 200 and the recess 202 are offset from the axis A, allowing keying during mounting.

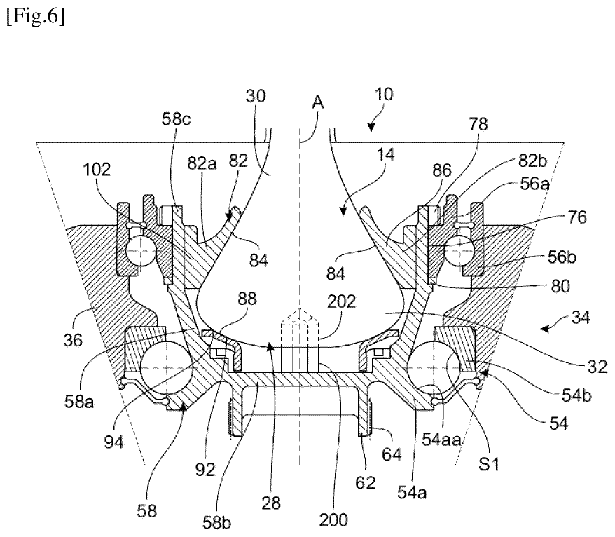

FIG. 6 illustrates a variant of the invention. The bottom wall 58b comprises a protuberance 200 configured to be engaged in a recess 202 of complementary shape to the free end 28, the protuberance 200 and the recess 202 being centred on the axis A.

The recess 202 may be formed in a metal material part of the root 14, for example in a metal insert of the root or in an end of the spar 22 when it is made of metal. Alternatively, the recess 202 can be formed in a composite material part of the root 14 and in particular spar 22.

Preferably, the protuberance 200 has a smaller cross-section than bulb 32 and stilt 30. The stilt 30 has a smaller cross-section than the bulb 32.

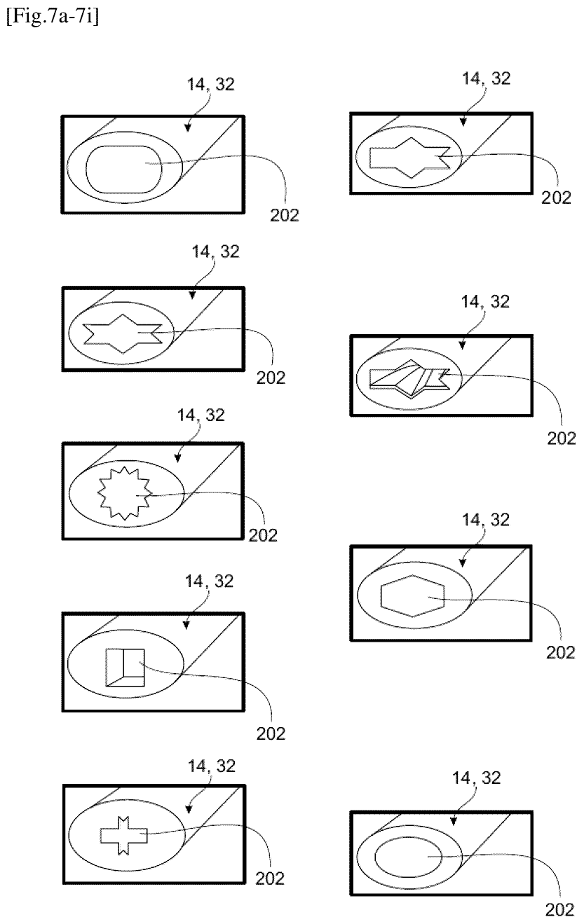

FIGS. 7a to 7i show different possible cross-sectional shapes of the recess 202 and the protuberance 200.

The shape is oval or elliptical in FIG. 7a with, for example, two flat sides diametrically opposed to the axis A.

The shape is star-shaped in FIG. 7b, with one or more legs of the star replaced by a rectangular part.

The shape is shown as a star in FIG. 7c.

The shape is star-shaped in FIG. 7d, but with an internal cross-section that varies and in particular decreases along axis A.

The shapes are polygonal in FIGS. 7e to 7g, and more precisely sun-shaped in FIG. 7e, hexagonal in FIG. 7f, and square in FIG. 7g.

The shape is round or elliptical in FIG. 7h.

And the shape is the same as in FIG. 7i, but with the ends of the legs identical in pairs.

The recess 202 can be produced by machining the root 14 or can be obtained directly from the mould, without any special reworking.

1. An assembly comprising a propeller vane and a system for angularly setting the pitch of the vane about an axis, called the pitch axis, for an aircraft turbomachine,
the vane having a root extending from an upper end connected to a blade of the vane to a free lower end, the root having a bulged section, called a “bulb”,
the system for angularly setting the pitch of the vane comprises a cup which is radially delimited by an annular wall extending around the pitch axis, the cup comprising a lower bottom closed by a bottom wall and an upper opening through which the bulb is intended to be inserted axially into the cup, the bottom wall being configured to cooperate in a form-fitting manner with the free end of the root in such a way that the cup is secured against rotation with the root about the pitch axis,
wherein the bottom wall comprises a protuberance which extends along the pitch axis and which is engaged in a recess of complementary shape to the free end of the root.

2. The assembly according to claim 1, wherein the recess and the protuberance are off-centre with respect to said pitch axis.

3. The assembly according to claim 1, wherein the recess and the protuberance are centred on said pitch axis.

4. The assembly according to claim 1, wherein the recess is formed in a metal material part of the root.

5. The assembly according to claim 1, wherein the recess is formed in a composite material part of the root.

6. The assembly according to claim 1, wherein the recess and the protuberance have, in cross-section, a shape selected from an ellipse, a star, a cross and a polygon.

7. The assembly according to claim 1, wherein the protuberance has a smaller cross-section than the bulb.

8. The assembly according to claim 1, wherein the bulb is connected to the blade by a stilt of smaller cross-section than the bulb.

9. The assembly according to claim 8, wherein the protuberance has a smaller cross-section than the stilt.

10. The assembly according to claim 1, wherein the bulb has a rounded convex cross-section all around the pitch axis.

11. The assembly according to claim 1, wherein the bulb is connected to the blade by a stilt of smaller cross-section than the bulb.

12. The assembly according to claim 11, wherein the protuberance has a smaller cross-section than the stilt.

13. The assembly according to claim 1, wherein the protuberance has a smaller cross-section than the bulb.

14. An aircraft turbomachine, comprising an assembly according to claim 1.
